(19) United States
(12) Patent Application Publication
(10) Pub. No.: US 2025/0372359 A1
(43) Pub. Date: Dec. 4, 2025

(54) SCIENTIFIC MASS SPECTROMETRY INSTRUMENT ELECTRICAL DIAGNOSTIC SYSTEMS

(71) Applicant: Thermo Finnigan LLC, San Jose, CA (US)

(72) Inventor: Oleg Silivra, Milpitas, CA (US)

(21) Appl. No.: 19/221,078

(22) Filed: May 28, 2025

Related U.S. Application Data
(60) Provisional application No. 63/653,304, filed on May 30, 2024.

(51) Int. Cl. H01J 49/00; H01J 49/02

(52) U.S. Cl. CPC H01J 49/0031; H01J 49/022

(57) ABSTRACT

Disclosed herein are scientific instrument support systems, as well as related methods, computing devices, and computer-readable media. For example, in some embodiments, a scientific instrument support apparatus comprising first logic to generate an electrical signal in a first component of a scientific instrument, wherein the generated electrical signal induces, through capacitive coupling, an electrical response signal in a second component of the scientific instrument, second logic to monitor the electrical response signal induced in the second component, third logic to determine an operational status of the second component based on the monitored electrical response signal, wherein the operational status indicates that the second component is not functioning properly when the monitored electrical response signal is not within a predetermined signal range is disclosed.

### CROSS-REFERENCE TO RELATED APPLICATIONS

This application claims priority to U.S. Provisional Application No. 63/653,304, filed May 30, 2024, titled “SCIENTIFIC MASS SPECTROMETRY INSTRUMENT ELECTRICAL DIAGNOSTIC SYSTEMS”, the entire disclosure of which is hereby incorporated by reference in its entirety.

### BACKGROUND

Scientific mass spectrometry instruments may include a complex arrangement of movable components, sensors, input and output ports, energy sources, and consumable components. Failures or changes in any part of this arrangement may result in a “downed” instrument, one that is not able to perform its intended function.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, not by way of limitation, in the figures of the accompanying drawings.

FIG. 1 is a schematic of an example mass spectrometer system, in accordance with various embodiments.

FIG. 2 is a schematic of an example mass spectrometer system including a control system and a plurality of components connected to the control system, in accordance with various embodiments.

FIG. 3 is a block diagram of an example scientific instrument support module for performing support operations, in accordance with various embodiments.

FIG. 4 is a flow diagram of an example method of performing support operations, in accordance with various embodiments.

FIG. 5 is a flow diagram of an example method of performing support operations, in accordance with various embodiments.

FIG. 6 is a graph illustrating an electrical response signal of a component under test that is functioning properly, in accordance with various embodiments.

FIG. 7 is a graph illustrating an electrical response signal of a component under test that is not functioning properly, in accordance with various embodiments.

FIG. 8 is a graph illustrating an electrical response signal of various components under test showing an instance where each component is functioning properly and an instance where each component is not functioning properly, in accordance with various embodiments.

FIG. 9 is a graph illustrating an electrical response signal of various components under test as compared to corresponding reference values, in accordance with various embodiments.

FIG. 10 is a graph illustrating electrical response signals for various components under test with varying orders in which electrical signals, or pulses, are generated in one or more other components, in accordance with various embodiments.

FIG. 11 is an example of a graphical user interface that may be used in the performance of some or all of the support methods disclosed herein, in accordance with various embodiments.

FIG. 12 is a block diagram of an example computing device that may perform some or all of the scientific instrument support methods disclosed herein, in accordance with various embodiments.

FIG. 13 is a block diagram of an example scientific instrument support system in which some or all of the scientific instrument support methods disclosed herein may be performed, in accordance with various embodiments.

### DETAILED DESCRIPTION

Disclosed herein are scientific instrument support systems, as well as related methods, computing devices, and computer-readable media. For example, in some embodiments, a scientific instrument support apparatus comprising first logic to generate an electrical signal in a first component of a scientific instrument, wherein the generated electrical signal induces, through capacitive coupling, an electrical response signal in a second component of the scientific instrument, second logic to monitor the electrical response signal induced in the second component, third logic to determine an operational status of the second component based on the monitored electrical response signal, wherein the operational status indicates that the second component is not functioning properly when the monitored electrical response signal is not within a predetermined signal range is disclosed.

Scientific instruments such as mass spectrometers, for example, include a number of electrical components within the mass spectrometer having a variety of functions. These components can include, for example, ion source components, mass analyzer components, and/or detector components. Some of these components can include electrodes, for example, in varying forms, arrangements, and/or sizes serving a specific purpose of the mass spectrometer such as, for example, altering the electromagnetic field to manipulate analytes. Some of these components can include other forms of electrically connected components. One or more of the components can be configured to receive a direct current (DC) signal and/or a radio frequency (RF) signal from one or more corresponding power supplies to energize the components in a desired manner to achieve a desired effect on an analyte, for example. These signals can be carried between one or more power supply components and/or control system circuits, for example, and the electrical components via electrical leads such as cables, for example, and intervening circuitry.

In some instances, the intervening circuitries, cables, and/or the components themselves may wear, fail, and/or degrade to a point where the components do not function properly. When a component is not functioning properly, it can cause one or more issues in the output signals of the mass spectrometer causing the mass spectrometer to not perform as intended. In at least one instance, an ion signal may not be present at all when one or more of the components is not functioning properly. When a cable and/or component is not functioning properly, it can be difficult for a user of the mass spectrometer to troubleshoot this problem. This can be because any one or more of the components of the mass spectrometer can result in a faulty output signal. The output signal cannot tell you which component is faulty.

In conventional approaches, the mass spectrometer is vented (one or more of the components are contained within a vacuum chamber under normal operation) so that each of the components, circuits, and/or the cables and cable connections to each component can be manually checked or tested and/or troubleshooted by a user. These approaches suffer from a number of technical problems and limitations. For example, this invasive diagnostic approach can cause the mass spectrometer to be down, or disabled, for a prolong period of time reducing lab and/or project efficiency. Such a diagnostic approach also requires manual testing of components introducing a human error element to the diagnostic process. Thus, there exists a need for a way to check the operational status of one or more of the components without venting the instrument to be able to quickly and accurately identify one or more faulty components, circuits, and/or connections to be able to quickly locate and fix the issue(s).

The scientific instrument support embodiments disclosed herein may achieve improved performance relative to conventional approaches. For example, in conventional approaches of diagnosing and/or troubleshooting the electrical connections of one or more components of a scientific instrument, venting of the instrument and a meticulous manual check is generally required of each individual component, circuitry, and/or component connection. The embodiments disclosed herein thus provide improvements to scientific instrument technology (e.g., improvements in the computer technology supporting such scientific instruments, among other improvements).

In some instances, one or more of the components carry an RF signal and a DC signal and, in combination, produce a desired effect on an analyte. In such an instance, such a component may appear to be functioning properly as the mass spectrometer and its control systems may check the component functionality by performing test on RF subsystem only, for example, by ramping up and dipping the RF signal. Such a component will appear to be fully operational when, in fact, the component is not functioning properly if DC lines are disconnected and/or failing, for example. Thus, there exists a need to be able to also diagnose components carrying both RF signal and DC signal that may appear to be working properly when RF signal is checked but, in fact, are not working properly.

Various ones of the embodiments disclosed herein may improve upon conventional approaches to achieve the technical advantages of lessening instrument downtime and/or increasing instrument use efficiency by automating the troubleshooting process and/or eliminating the need to vent an instrument to troubleshoot output signal issues of an instrument. Such technical advantages are not achievable by routine and conventional approaches, and all users of systems including such embodiments may benefit from these advantages (e.g., by assisting the user in the performance of a technical task, such as locating and/or troubleshooting one or more component issues, by means of a guided human-machine interaction process). The technical features of the embodiments disclosed herein are thus decidedly unconventional in the field of scientific instruments such as mass spectrometers, for example, as are the combinations of the features of the embodiments disclosed herein. As discussed further herein, various aspects of the embodiments disclosed herein may improve the functionality of a computer itself; for example, the systems and methods disclosed herein may automate the troubleshooting and/or diagnosing process when output signals of a scientific instrument indicate that there is an issue with one or more of the components of the scientific instrument, provide deeper analysis of the issues, and/or recommending fixes for the identified component issues. The computational and user interface features disclosed herein do not only involve the collection and comparison of information, but apply new analytical and technical techniques to change the operation of the troubleshooting process. The present disclosure thus introduces functionality that neither a conventional computing device, nor a human, could perform.

The methods and systems disclosed herein may provide a way to accurately and efficiently determine the operational status of one or more components that carry at least some DC signal without venting the instrument. The methods and systems disclosed herein utilize capacitive coupling between one or more components of a mass spectrometer to induce one or more electrical response signals in a component or components under test by way of capacitive coupling. In at least one instance, the mass spectrometer is set to a standby mode. In at least one instance, the standby mode includes setting all of the components to a zero electrical potential. An electrical signal, or pulse, is then generated in a neighbor component, or components, to induce an electrical response signal in a component, or components, under test. The generated electrical signal in the neighbor component induces, through capacitive coupling, an electrical response signal in the component under test. The electrical response signal is monitored and, based on the monitored response signal, an operational status of the component under test is determined. For example, if the electrical response signal is within a predetermined signal range which would indicate a fully operational component, the operational status of the component under test is determined to be operational. If the electrical response signal is outside of the predetermined range, for example, the operational status of the component under test is determined to be not functioning properly. In at least one instance, many electrical pulses are sent and corresponding electrical response signals are monitored. In such an instance, an average of the electrical response signals is utilized when determining whether the component(s) under test is functioning properly. In at least one instance, a neighbor component is referred to as a component in close enough physical proximity to the component(s) under test such that an electrical response signal can be generated in the component(s) under test through capacitive coupling when an electrical signal is generated in the neighbor component.

In at least one instance, the components which may be directly tested and/or used in testing of other components using the methods and systems disclosed herein can include any of the components disclosed herein. In at least one instance, the components include quadrupoles, ion traps, ion optic components, lenses, deflectors, ion guides, ion mirrors, detector components, and/or detectors, for example. Any electrically connected component of a mass spectrometer may be capable of having an electrical response signal induced by one or more neighboring electrically connected components. The methods and systems disclosed herein can be extended to at least some or all of these components.

Accordingly, the embodiments of the present disclosure may serve any of a number of technical purposes, such as controlling a specific technical system or process; determining from measurements how to control and/or fix a machine by identifying and displaying detected issues and/or potential fixes for instrument components, for example; digital audio, image, or video enhancement or analysis by presenting detected component issues to a user and providing a user with further analysis of the detected component issues.

The embodiments disclosed herein thus provide improvements to scientific instrument technology (e.g., improvements in the computer technology supporting scientific instruments such as mass spectrometers, for example, among other improvements).

In the following detailed description, reference is made to the accompanying drawings that form a part hereof wherein like numerals designate like parts throughout, and in which is shown, by way of illustration, embodiments that may be practiced. It is to be understood that other embodiments may be utilized, and structural or logical changes may be made, without departing from the scope of the present disclosure. Therefore, the following detailed description is not to be taken in a limiting sense.

Various operations may be described as multiple discrete actions or operations in turn, in a manner that is most helpful in understanding the subject matter disclosed herein. However, the order of description should not be construed as to imply that these operations are necessarily order dependent. In particular, these operations may not be performed in the order of presentation. Operations described may be performed in a different order from the described embodiment. Various additional operations may be performed, and/or described operations may be omitted in additional embodiments.

For the purposes of the present disclosure, the phrases “A and/or B” and “A or B” mean (A), (B), or (A and B). For the purposes of the present disclosure, the phrases “A, B, and/or C” and “A, B, or C” mean (A), (B), (C), (A and B), (A and C), (B and C), or (A, B, and C). Although some elements may be referred to in the singular (e.g., “a processing device”), any appropriate elements may be represented by multiple instances of that element, and vice versa. For example, a set of operations described as performed by a processing device may be implemented with different ones of the operations performed by different processing devices. As used herein, the phrase “based on” should be understood to mean “based at least in part on,” unless otherwise specified.

The description uses the phrases “an embodiment,” “various embodiments,” and “some embodiments,” each of which may refer to one or more of the same or different embodiments. Furthermore, the terms “comprising,” “including,” “having,” and the like, as used with respect to embodiments of the present disclosure, are synonymous. When used to describe a range of dimensions, the phrase “between X and Y” represents a range that includes X and Y. As used herein, an “apparatus” may refer to any individual device, collection of devices, part of a device, or collections of parts of devices. The drawings are not necessarily to scale.

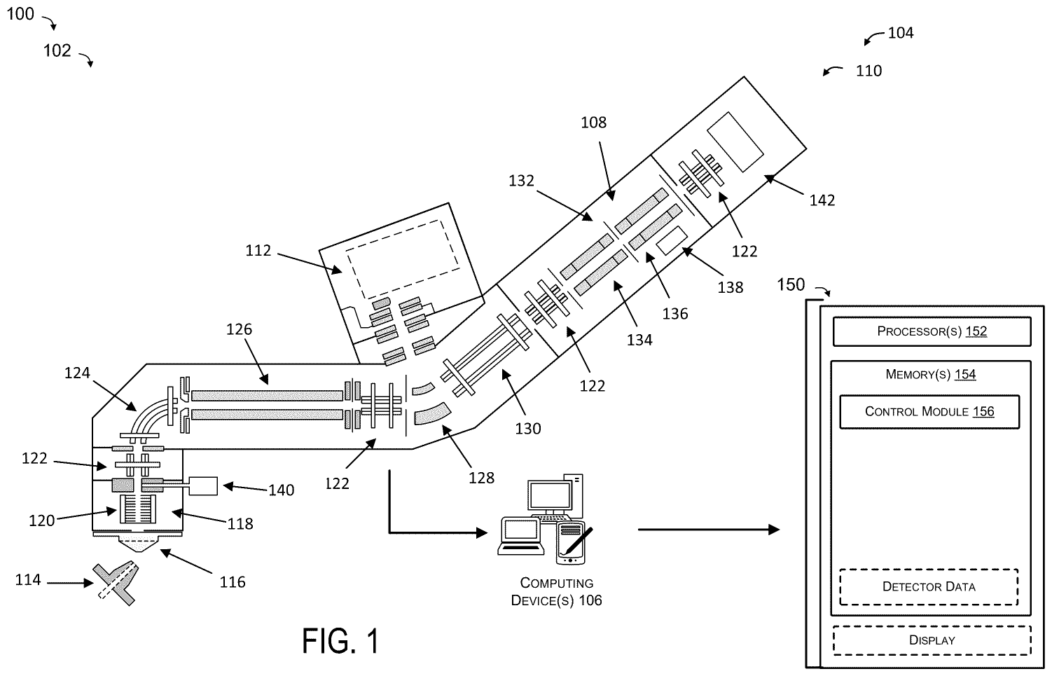

FIG. 1 illustrates example environments 100 for the scientific instrument support systems and methods disclosed herein. FIG. 1 includes a number of features that are not discussed in detail herein for clarity of exposition, but the purpose and operation of these features will be understood by one of ordinary skill in the art and may take any suitable form. Any of the features of FIG. 1 may be used in combination with any suitable ones of the features of other of the accompanying drawings and/or in combination with any suitable ones of the features of the embodiments disclosed herein.

FIG. 1 shows an example environment 102 that includes an example mass spectrometer system 104 for use with the scientific instrument support systems and methods disclosed herein, and computing devices 106 configured to control the operation of the mass spectrometer system 104 and/or perform post processing on detector data generated therefrom. It is noted that present disclosure is not limited to the environments of FIG. 1 and that in some embodiments the environments 100 may include a different type of system that is configured to manipulate and/or otherwise examine ions.

FIG. 1 shows the example mass spectrometer system 104 as being a hybrid mass spectrometer 110, comprising more than one type of mass analyzer. Specifically, the mass spectrometer system 104 includes a quadrupole ion trap mass analyzer 108 as well as an electrostatic trap mass analyzer 112 (e.g., ORBITRAP™ analyzer). However, it is understood that different combinations of mass analyzers are desirous for different applications, and thus according to the present disclosure example the mass spectrometer system 104 may include a fewer or greater number of mass analyzers and/or comprise different combinations of mass analyzers.

In operation of the example mass spectrometer system 104, an electrospray ion source 114 provides ions of a sample to be analyzed to an aperture of a heated ion transfer tube 116, at which point the ions enter into a first vacuum chamber 118. After entry, the ions are captured and focused into a tight beam by an ion collimating device 120 (e.g., a stacked-ring ion guide, an ion lens, an ion funnel, etc.). The example mass spectrometer 110 further shows as including a plurality of ion optical transfer components 122 that are configured to allow ions to pass between intermediate-vacuum regions of the mass spectrometer during travel. Example mass spectrometer 110 is illustrated as including a curved beam guide 124 that separates most remaining neutral molecules and undesirable ion clusters (e.g., solvated ions, environmental contaminants, etc.) from the ion beam.

A quadrupole mass filter 126 of the mass spectrometer system 110 is used in its conventional sense as a tunable mass filter so as to pass ions only within a selected m/z range. A subsequent ion optical transfer component 122 delivers the filtered ions to a curved ion trap (“C-trap”) component 128. The C-trap 128 is able to transfer ions along a pathway between the quadrupole mass filter 126 and the ion trap mass analyzer 108. The C-trap 128 also has the capability to temporarily collect and store a population of ions and then deliver the ions, as a pulse or packet, into the mass analyzer 112.

FIG. 1 further shows a multipole ion guide 130 and an optical transfer component 122 as serving to guide ions between the C-trap 128 and the ion trap mass analyzer 108. The multipole ion guide 130 may provide temporary ion storage capability such that ions produced in a first processing step of an analysis method can be later retrieved for processing in a subsequent step. The multipole ion guide 130 may also serve as a fragmentation cell and ion trap (i.e., an ion routing multipole). Various ion optics along the pathway between the C-trap 128 and the ion trap mass analyzer 108 may be controllable such that ions may be transferred in either direction, depending upon the sequence of ion processing steps required in a particular analysis method.

The ion trap mass analyzer 108 is illustrated in FIG. 1 as being a dual-pressure linear ion trap 132 (i.e., a two-dimensional trap) comprising a high-pressure linear trap cell 134 and a low-pressure linear trap cell 136, the two cells being positioned adjacent to one another and separated by a plate lens having a small aperture that permits ion transfer between the two cells and that also acts as a pumping restriction that allows different pressures to be maintained in the two traps.

The use of either electron transfer dissociation or a proton transfer reaction, within a mass analysis method, requires the capability of performing controlled ion-ion reactions within a mass spectrometer. Ion-ion reactions, in turn, require the capabilities of generating reagent ions, and of causing the reagent ions to mix with sample ions. The example mass spectrometer system 110 is depicted as including a reagent-ion source 140 disposed between the stacked-ring ion guide 120 and the curved beam guide 124. However, within the present disclosure one or more additional reagent-ion sources may be included in an example mass spectrometer system 104. FIG. 1 further illustrates the example spectrometer 110 as including one or more additional components 142. Such additional components may include various combinations of one or more ion guides, ion traps, lenses, detectors, reagent ion sources, etc. A person having skill in the art would appreciate that example spectrometer 110 is merely an example configuration of a system capable of enabling/performing the system and methods for low Mathieu q dissociation of precursor ions disclosed herein.

The environment 100 is also shown as including one or more computing device(s) 106. Those skilled in the art will appreciate that the computing devices 106 depicted in FIG. 1 are merely illustrative and are not intended to limit the scope of the present disclosure. The computing system and devices may include any combination of hardware or software that can perform the indicated functions, including computers, network devices, internet appliances, PDAs, wireless phones, controllers, oscilloscopes, amplifiers, etc. The computing devices 106 may also be connected to other devices that are not illustrated, or instead may operate as a stand-alone system.

It is also noted that one or more of the computing device(s) 106 may be a component of the example mass spectrometers 104, may be a separate device from the example mass spectrometers 104 which is in communication with the example mass spectrometers 104 via a network communication interface, or a combination thereof. For example, an example mass spectrometers 104 may include a first computing device 106 that is a component portion of the example mass spectrometers 104, and which acts as a controller that drives the operation of the example mass spectrometers 104 (e.g., adjust the scanning location on the sample by operating the scan coils, etc.). In such an embodiment the example mass spectrometers 104 may also include a second computing device 106 that is a desktop computer separate from the example microscope system(s) 104, and which is executable to process data received from the detector system 138 to generate representations of the spectra based on the detector data (e.g., chromatograms, extracted ion current (EIC) profiles, etc.) and/or perform other types of analysis or post-processing of the detector data. The computing devices 106 may further be configured to receive user selections via a keyboard, mouse, touchpad, touchscreen, wireless devices, other user interface, etc.

Additionally, the computing device(s) 106 are configured to control the example mass spectrometers 104 to allow for the performance a mass spectrometry analysis on a sample. For example, one or more user selections, an automation program, or a combination thereof may allow the computing devices 110 to cause mass spectrometers 104 and/or components thereof to perform any of the methods described in the present disclosure, and using any of the parameters described herein or which are widely understood by persons having skill in the art as being part of performing such methods.

User selections, an automation program, or a combination thereof may then cause the computing devices 110 to generate analyze detector data from the mass spectrometers 104 relating to a sample, and/or create one or more chromatograms associated with the performed mass spectroscopy analysis of the samples.

FIG. 1 further includes a schematic diagram illustrating an example computing architecture 150 of the computing devices 105. Example computing architecture 150 illustrates additional details of hardware and software components that can be used to implement the techniques described in the present disclosure. Persons having skill in the art would understand that the computing architecture 150 may be implemented in a single computing device 106 or may be implemented across multiple computing devices. For example, individual modules and/or data constructs depicted in computing architecture 150 may be executed by and/or stored on different computing devices 106. In this way, different process steps of the inventive methods disclosed herein may be executed and/or performed by separate computing devices 106 and in various orders within the scope of the present disclosure. In other words, the functionality provided by the illustrated components may in some implementations be combined in fewer components or distributed in additional components. Similarly, in some implementations, the functionality of some of the illustrated components may not be provided and/or other additional functionality may be available.

In the example computing architecture 150, the computing device includes one or more processors 152 and memory 154 communicatively coupled to the one or more processors 152. While not intended to be limiting, example computing architecture 150 is shown as including a control module 166 stored in the memory 154. As used herein, the term “module” is intended to represent example divisions of executable instructions for purposes of discussion and is not intended to represent any type of requirement or required method, manner, or organization. Accordingly, while various “modules” are described, their functionality and/or similar functionality could be arranged differently (e.g., combined into a fewer number of modules, broken into a larger number of modules, etc.). Further, while certain functions and modules are described herein as being implemented by software and/or firmware executable on a processor, in other instances, any or all of modules can be implemented in whole or in part by hardware (e.g., a specialized processing unit, etc.) to execute the described functions. As discussed above in various implementations, the modules described herein in association with the example computing architecture 150 can be executed across multiple computing devices 106.

The control module 168 can be executable by the processors 152 to cause a computing device 110 and/or example mass spectrometers 104 to take one or more actions and/or perform functions or maintenance of the systems. In some embodiments, the control module 168 may cause the example mass spectrometers 104 to perform a mass spectrometry analysis on a sample. More specifically, according to the present disclosure, the example control module 168 can be executable to cause mass spectrometers 104 and/or components thereof to perform any of the methods described in the present disclosure and using any of the parameters described herein or which are widely understood by persons having skill in the art as being part of performing such methods.

As discussed above, the computing devices 106 include one or more processors 152 configured to execute instructions, applications, or programs stored in a memory(s) 154 accessible to the one or more processors. In some examples, the one or more processors 152 may include hardware processors that include, without limitation, a hardware central processing unit (CPU), a graphics processing unit (GPU), and so on. While in many instances the techniques are described herein as being performed by the one or more processors 152, in some instances the techniques may be implemented by one or more hardware logic components, such as a field programmable gate array (FPGA), a complex programmable logic device (CPLD), an application specific integrated circuit (ASIC), a system-on-chip (SoC), or a combination thereof.

The memories 154 accessible to the one or more processors 152 are examples of computer-readable media. Computer-readable media may include two types of computer-readable media, namely computer storage media and communication media. Computer storage media may include volatile and non-volatile, removable, and non-removable media implemented in any method or technology for storage of information, such as computer readable instructions, data structures, program modules, or other data. Computer storage media includes, but is not limited to, random access memory (RAM), read-only memory (ROM), erasable programmable read only memory (EEPROM), flash memory or other memory technology, compact disc read-only memory (CD-ROM), digital versatile disk (DVD), or other optical storage, magnetic cassettes, magnetic tape, magnetic disk storage or other magnetic storage devices, or any other non-transmission medium that may be used to store the desired information and which may be accessed by a computing device. In general, computer storage media may include computer executable instructions that, when executed by one or more processing units, cause various functions and/or operations described herein to be performed. In contrast, communication media embodies computer-readable instructions, data structures, program modules, or other data in a modulated data signal, such as a carrier wave, or other transmission mechanism. As defined herein, computer storage media does not include communication media.

Those skilled in the art will also appreciate that items or portions thereof may be transferred between memory 154 and other storage devices for purposes of memory management and data integrity. Alternatively, in other implementations, some or all the software components may execute in memory on another device and communicate with the computing devices 106. Some or all of the system components or data structures may also be stored (e.g., as instructions or structured data) on a non-transitory, computer accessible medium or a portable article to be read by an appropriate drive, various examples of which are described above. In some implementations, instructions stored on a computer-accessible medium separate from the computing devices 106 may be transmitted to the computing devices 106 via transmission media or signals such as electrical, electromagnetic, or digital signals, conveyed via a communication medium such as a wireless link. Various implementations may further include receiving, sending, or storing instructions and/or data implemented in accordance with the foregoing description upon a computer-accessible medium.

The mass spectrometer system 104 can further include one or more power supplies and corresponding circuits connected to one or more of the mass spectrometer components discussed herein. The one or more power supplies and corresponding circuits can be coupled to the computing devices 106 for controlling the one or more power supplies and, thus, the mass spectrometer components and for receiving outputs from the corresponding circuits to monitor one or more electrical parameters (e.g., voltage and/or current), within the circuit, mass spectrometer component, and/or power supply, for example. In at least one instance, the corresponding circuits include one or more feedback circuits to provide an electrical signal monitoring circuit to measure and monitor one or more electrical parameters across one or more of the components. These electrical parameters can be monitored and recorded by computing devices such as those disclosed herein.

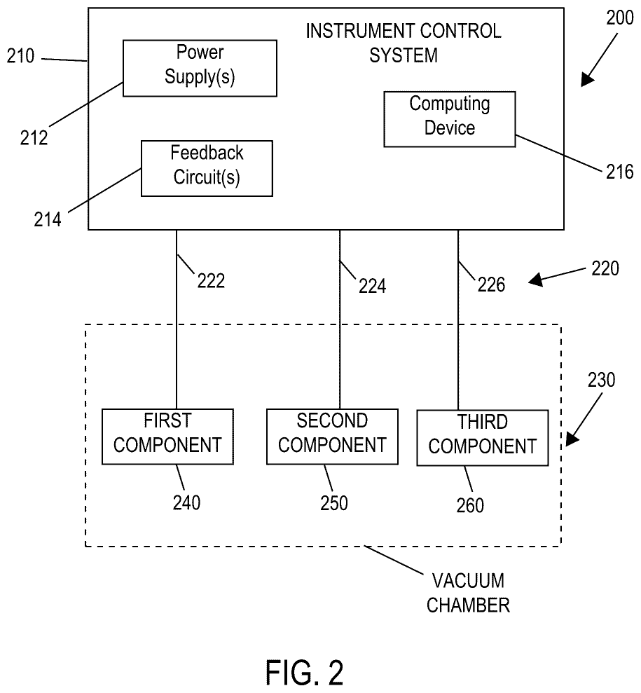

FIG. 2 is a block diagram of an example scientific instrument system 200 for use with the support systems, scientific instruments, and/or methods disclosed herein. The scientific instrument system 200 can comprise any suitable type of scientific instrument system such as, for example, a mass spectrometer system such as those disclosed herein, for example. The scientific instrument system 200 comprises a control system 210 and a plurality of instrument components 230 connected to the control system 210. The control system 210 includes one or more power supplies 212, one or more feedback circuits 214, and a computing device 216. The control system 210 is configured to control various parameters of the components 230 such as for example, electrical signal parameters (current, voltage, DC signals, RF signals, e.g.). The one or more power supplies 212 are connected to one or more of the components 230 to provide electrical signals thereto during normal use and/or during the performance of the methods and systems disclosed herein, such as the electrical diagnostic methods disclosed herein, for example. The feedback circuits 214 are connected to (and/or are part of) the one or more power supplies 212 and/or one or more power supply circuits, the computing device 216, and the components 230 so as to provide circuitry for monitoring and/or measuring electrical signals at the output of the one or more power supplies 212 (which correspond to the electrical signals delivered to the components 230) during normal use and/or during the performance of the methods and systems disclosed herein, such as the electrical diagnostic methods disclosed herein, for example.

In at least one instance, the feedback circuit can be part of a power supply and a portion of the output of the power supply is consumed by the feedback circuit for monitoring and/or measurement (e.g., by a resistive voltage divider). In such an instance, the actual output (e.g. voltage and/or current) of the power supply to a particular component can be calculated based on a known relationship. In at least one instance, each component is powered by its own power supply. In at least one instance, each component is connected to one or more distribution boards. At any rate, the voltage potential of each component's circuit can be monitored allowing for the current induced into each component via capacitive coupling as discussed herein to be monitored. In at least one instance, one or more feedback circuits and/or measuring devices allow for the monitoring of electrical signals of each component during normal operation. The feedback circuits and/or measuring devices can include circuitry and a device to measure electrical potential within the circuit containing the component and the power supply, for example. The feedback circuits and/or measuring devices can be connected to a computing device to monitor, record, display the feedback. The feedback can then be used to further control the components. These one or more feedback circuits can also be used to monitor electrical potential within the circuit containing the component and the power supply, for example, which is induced during the diagnostic methods discussed herein.

The components 230 include a first component 240, a second component 250, and a third component 260. The components 230 can include any of the scientific instrument components discuss herein such as mass spectrometer components, for example. Each of the components 230 are connected to the control system 210 via electrical circuitry 220 including sub circuits, cables, and/or electrical leads. In at least one instance, the electrical circuitry 220 comprises a single cable, electrical lead, and/or wire connecting each component to the control system 210 (carrying analogue and/or digital signals, e.g.). The first component 240 is connected to the control system 210 via the electrical circuitry 222, the second component 250 is connected to the control system 210 via electrical circuitry 224, and the third component 260 is connected to the control system 210 via electrical circuitry 226. More or less components are contemplated. The proximity of the components 230 may vary positionally and/or the order of the components 230 may vary operationally. In at least one instance, the components 230 include components that are sequentially positioned in the operation of a scientific instrument such as a mass spectrometer, for example. In at least one instance, the components 230 include components that are positioned in close proximity to each other where one or more of the components 230 can induce an electrical response signal, via capacitive coupling, in one or more other of the components 230. Discussed in greater detail herein, the circuitry 220 and/or components 230 may fail, become disconnected, or wear, over time and the methods and systems disclosed herein allow for the identification of such failures, or issues, for example. As can be seen in FIG. 2, the components 230 are positioned in a vacuum chamber such as the vacuum chamber 118 where, during at least some portion of operation of the instrument system 200, the components 230 are in still in a vacuum state within the vacuum chamber (as is the case during normal instrument operation). As discussed herein, the methods and systems disclosed herein allow for the diagnosis of connection and/or circuitry issues of the components 220 without venting the vacuum chamber 118.

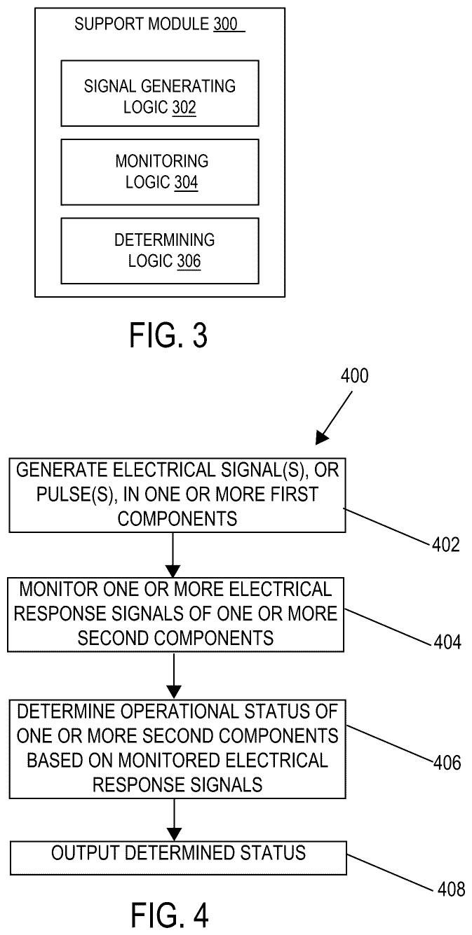

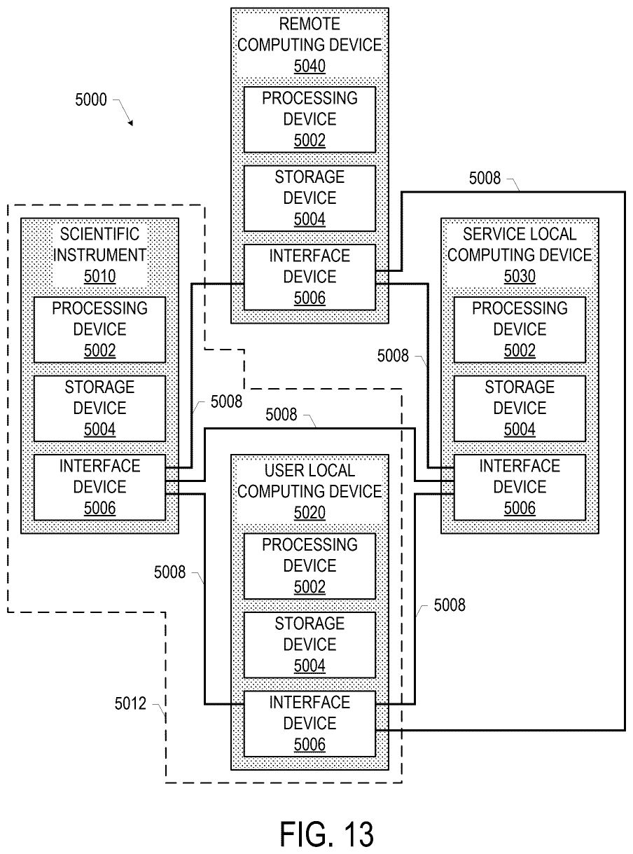

FIG. 3 is a block diagram of a scientific instrument support module 300 for performing support operations, in accordance with various embodiments. The scientific instrument support module 300 may be implemented by circuitry (e.g., including electrical and/or optical components), such as a programmed computing device. The logic of the scientific instrument support module 300 may be included in a single computing device, or may be distributed across multiple computing devices that are in communication with each other as appropriate. Examples of computing devices that may, singly or in combination, implement the scientific instrument support module 300 are discussed herein with reference to the computing device 4000 of FIG. 12, and examples of systems of interconnected computing devices, in which the scientific instrument support module 300 may be implemented across one or more of the computing devices, is discussed herein with reference to the scientific instrument support system 5000 of FIG. 13.

The scientific instrument support module 1000 may include signal generating logic 302, signal monitoring logic 304, and determining logic 306. As used herein, the term “logic” may include an apparatus that is to perform a set of operations associated with the logic. For example, any of the logic elements included in the support module 300 may be implemented by one or more computing devices programmed with instructions to cause one or more processing devices of the computing devices to perform the associated set of operations. In a particular embodiment, a logic element may include one or more non-transitory computer-readable media having instructions thereon that, when executed by one or more processing devices of one or more computing devices, cause the one or more computing devices to perform the associated set of operations. As used herein, the term “module” may refer to a collection of one or more logic elements that, together, perform a function associated with the module. Different ones of the logic elements in a module may take the same form or may take different forms. For example, some logic in a module may be implemented by a programmed general-purpose processing device, while other logic in a module may be implemented by an application-specific integrated circuit (ASIC). In another example, different ones of the logic elements in a module may be associated with different sets of instructions executed by one or more processing devices. A module may not include all of the logic elements depicted in the associated drawing; for example, a module may include a subset of the logic elements depicted in the associated drawing when that module is to perform a subset of the operations discussed herein with reference to that module.

The signal generating logic 302 is configured to generate one or more electrical signals, or pulses, in one or more components of a scientific instrument such as, for example, a mass spectrometer.

In at least one instance, the electrical signal is generated by the one or more power supplies connected to one or more components. In at least one instance, characteristics of the electrical signal are defined by a user, are predefined, and/or are determined by the computing device.

The signal monitoring logic 304 is configured to monitor one or more electrical response signals induced in one or more other components under test as a result of the generated electrical signals, or pulses, generated by the signal generating logic 302. The signal monitoring logic 304 monitors the electrical response signals through the one or more feedback circuits and/or measuring devices connected to the one or more other components under test.

In at least one instance, the signal monitoring logic 304 further monitors the generated electrical signal in the circuitry connected to the one or more components that are responsible for inducing current in the one or more other components under test to ensure that the generated electrical signal is being generated as expected. For example, various characteristics of the generated electrical signal can be monitored and compared to input characteristics.

The determining logic 306 is configured to determine the operational status of the one or more of the other components under test within which an electrical response signal was (or was supposed to be) induced based on the monitored one or more electrical response signals induced in the one or more other components under test. In at least one instance, the monitored electrical response is compared against a operational threshold. In at least one instance, the monitored electrical response is an average of many monitored electrical response signals induced via many generated test pulses and the average monitored electrical response is used to determine the operational status of the one or more components under test.

In some instances, additional logic may be employed. For example, analysis logic may be employed where additional analysis of the monitored electrical response signals can be performed, determining logic may be employed where a potential fix for a component under test which was determined to be not operating properly can be determined based on the monitored electrical response signal(s), and/or display logic may be employed to display, to a user, the results of the methods or systems disclosed herein to help identify component issues and/or determine next steps for resolving the identified issues.

In at least one instance, the support module 300 is configured to sequentially run through tests of many, or all, of the components of the scientific instrument. For example, the support module 300 can walk through a predetermined set, some, or all, of the components of the instrument in an effort to induce an electrical response signal in and monitor the electrical response signal of all of the components to determine the operational status of each component. A report of the results can be displayed to user identifying the components which may have been identified to be faulty, malfunctioning, not fully operational, and/or disconnected, for example. In at least one instance, further analysis of the report can be performed by one or more computing devices to determine potential fixes and next steps. In at least one instance, further logic may be included which may attempt to self-correct and/or verify detected issues. For example, if generating an electrical signal in a first component does not induce an expected electrical response signal in a second component, the support module 3000 may automatically initiate a double check, or verification test, by generating an electrical signal in a third component to induce a second expected electrical response signal in the second component under test. If the electrical response signal in the second component is still not as expected, the support module 300 can determine that the second component and/or its subcomponents may be disconnected or not functioning properly. On the other hand, if the electrical response signal in the second component indicates that the second component is functioning properly, then the support module 300 can determine that the first component and/or its subcomponents may be faulty.

In at least one instance, the support module 300 further includes instrument test logic which sets the instrument to standby to automatically run a diagnostic test of each and every component upon instrument shutdown and/or startup, for example. In at least one instance, the diagnostic test can be initiated by a user on demand. In at least one instance, the diagnostic test is performed for each component multiple times during a signal diagnostic test run. The pulses can be sent and corresponding signals monitored many thousands of times per second. Accordingly, the diagnostic can be performed quickly and in the background in between instrument runs, for example.

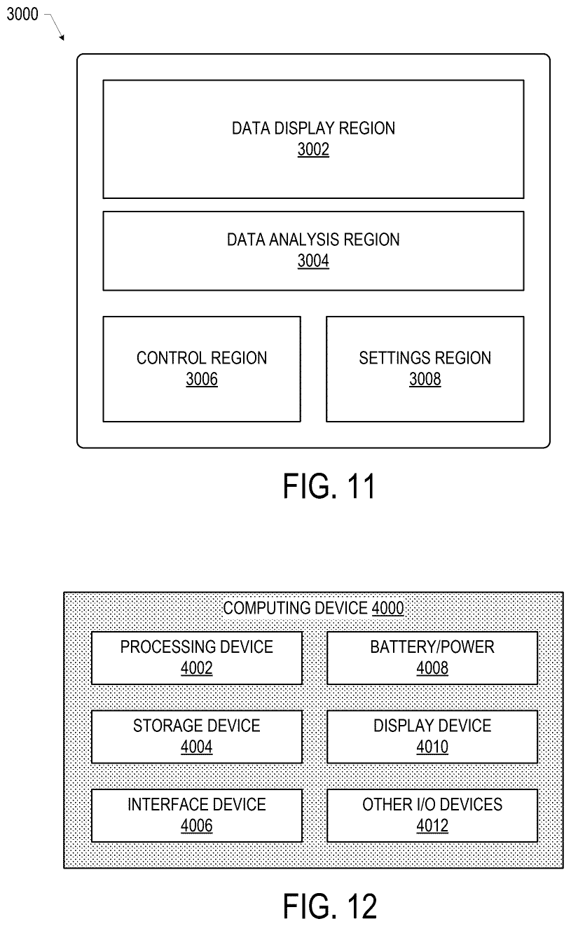

FIG. 4 is a flow diagram of a method 400 of performing support operations, in accordance with various embodiments. Although the operations of the method 400 may be illustrated with reference to particular embodiments disclosed herein (e.g., the scientific instrument support modules 300 discussed herein with reference to FIG. 3, the GUI 3000 discussed herein with reference to FIG. 11, the computing devices 4000 discussed herein with reference to FIG. 12, and/or the scientific instrument support system 5000 discussed herein with reference to FIG. 13), the method 400 may be used in any suitable setting to perform any suitable support operations. Operations are illustrated once each and in a particular order in FIG. 4, but the operations may be reordered, modified, and/or repeated as desired and appropriate (e.g., different operations performed may be performed in parallel, as suitable).

At 402, generating a test pulse (DC) in a first component may be performed. For example, the generating logic 302 of a support module 300 may perform the operations of 402. The operations of 402 may include generating a test pulse with one or more power supplies of the mass spectrometer, for example, in a first component to induce an electrical response signal in a second component under test.

At 404, monitoring an electrical parameter of the second component under test may be performed. For example, the monitoring logic 304 of a support module 300 may perform the operations of 404. The operations of 404 may include monitoring, through a feedback circuit connected to the second component under test, an electrical response signal (voltage and/or current, for example) induced in the second component under test as a result of the generation of the test pulse in the first component.

At 406, determining the operational status of the second component under test based on the monitored electrical response signal of the second component under test may be performed. For example, the determining logic 306 of a support module 300 may perform the operations of 406. Determining the operational status of the second component under test may include comparing the monitored electrical response signal to a predetermined response signal including predetermined characteristics (e.g., threshold, spectral composition, etc.) where, if the monitored electrical response signal is within a predetermined range which would indicate that the second component under test is functioning properly, then the operational status is determined to be fully operational, or functioning properly and where, if the monitored electrical response signal is outside (below or above) of the aforementioned predetermine range, then the operational status is determined to be faulty or not functioning properly, for example.

At 408, outputting the determined operational status may be performed. Such an output can include displaying the results to a user, for example, or any of the other subsequent steps disclosed herein such as, for example, outputting the operational status and/or corresponding results to a determining logic that determines what the issue is with the second component under test. In at least one instance, the method 400 can further include steps to log, watch, and predict trends after cycling through many test sequences to be able to predict that a component and/or its cables, connections, circuitry may fail in the near future. This analysis can be performed by logging the change of the electrical response signals over time and comparing the change over time to previous failure events, for example. Based on a threshold similarity, the support module 300 can determine that a component and/or its subcomponents, for example, is likely to fail or become faulty and/or disconnected in the near future. This information can be conveyed to a user along with the supporting evidence that the module 300 used to make this determination.

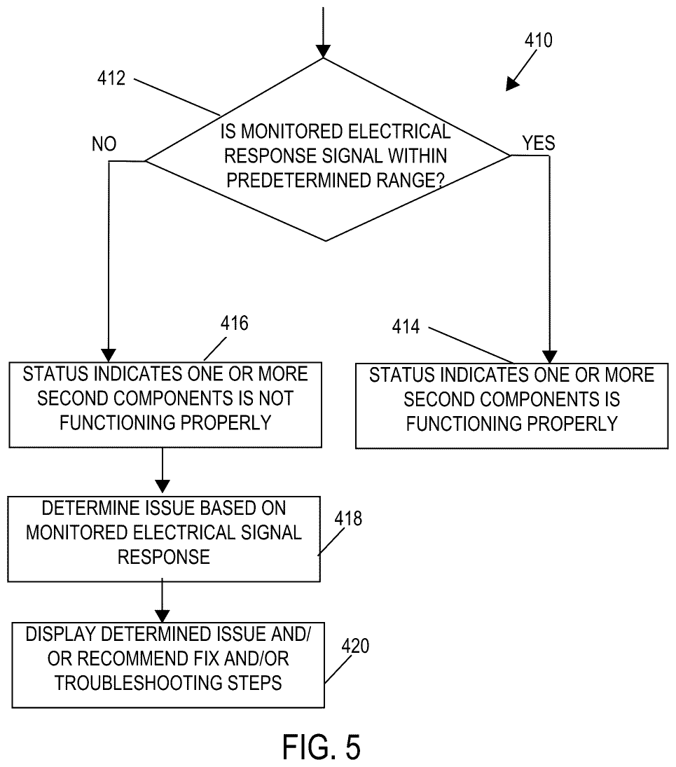

FIG. 5 is a flow diagram of a method 410 of performing support operations, in accordance with various embodiments. In at least one instance, the method 410 is performed in conjunction with the method 400. Although the operations of the method 410 may be illustrated with reference to particular embodiments disclosed herein (e.g., the scientific instrument support modules 300 discussed herein with reference to FIG. 3, the GUI 3000 discussed herein with reference to FIG. 11, the computing devices 4000 discussed herein with reference to FIG. 12, and/or the scientific instrument support system 5000 discussed herein with reference to FIG. 13), the method 400 may be used in any suitable setting to perform any suitable support operations. Operations are illustrated once each and in a particular order in FIG. 5, but the operations may be reordered, modified, and/or repeated as desired and appropriate (e.g., different operations performed may be performed in parallel, as suitable). Operations may also be combined with the other methods and systems disclosed herein.

At 412, the method determines if the monitored electrical response signal is within a predetermined range. For example, the determining logic 306 of a support module 300 may perform the operations of 412. The operations of 412 may include comparing the electrical response signal(s) to a predetermined range to determine if the component under test is functioning properly or not functioning properly. In at least one instance, an average of the electrical response signals is compared to a single reference value. If the average of the electrical response signals is within a predefined percentage of the single reference value, the component is determined to be fully operational. If the average of the electrical response signals is outside of the predefined percentage of the single reference value, the component is determined to be faulty, or not functioning properly. In at least one instance, a single electrical response signal monitored is determined to be within a predefined reference range, for example. If the signal is within the predefined reference range, the component is determined to be fully operational. If the signal is outside of the predefined reference range, the component is determined to be faulty, or not fully operational. In at least one instance, an average of the electrical response signals is compared against a predetermined reference range.

In at least one instance, the predetermined values or reference ranges, for example, against which the monitored electrical response signals are compared are determined by a manufacturer. In at least one instance, the values and/or ranges are determined locally by an instrument and are based on normal operating conditions of that specific instrument. In another instance, the values and/or ranges are selected by a user. In at least one instance, artificial intelligence and/or machine learning is used to determine what the reference values and/or ranges are for each component.

At 414, it is determined that the monitored electrical response signal is within the predetermined range indicating that the component under test is fully operational. In at least one instance, this determination is displayed to a user. In at least one instance, this determination is not displayed to a user and, rather, a test of another component is automatically initiated.

At 416, it is determined that the monitored electrical response signal is outside of the predetermined range indicating that the component under test is not fully operational or is not functioning properly. At 418, an issue can be determined by the support module 300, for example, based on the monitored electrical response signal(s). In other words, one or more characteristics of the electrical response signal may provide insight on what is wrong with the component under test. These characteristics and corresponding signal response profiles which indicate specific issues can be learned over time by a machine learning algorithm and/or can be predefined by a manufacture. In at least one instance, the electrical signal response profile can indicate, for example, that the component is completely disconnected. In another instance, the electrical signal response profile can indicate, for example, that one or more components of the sub-circuitry of the component under test has failed and/or is faulty, for example. In at least one instance, the electrical response signal may indicate exactly which circuit component has failed based on prior test results in other labs with an identical issue.

At 420, the determined issue and/or a recommended fix for the issue can be displayed or otherwise conveyed to a user and/or a service provider (manufacture, for example). In at least one instance, steps for how to fix the issue are acquired by the support module 300 and conveyed to a user.

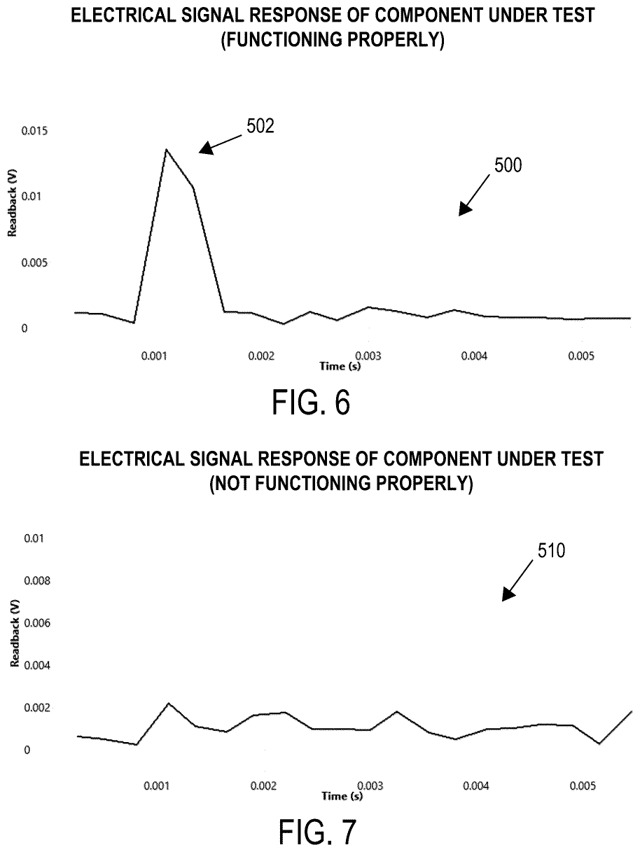

FIGS. 6 and 7 illustrate graphs of examples of a monitored electrical signal response of a component under test. FIG. 6 is a graph 500 depicting a monitored electrical signal response of a component under test which is functioning properly. As can be seen in the graph 500, the electrical response signal includes a spike 502. The spike 502 was induced by an electrical test pulse generated in one or more other components of the scientific instrument.

FIG. 7 is a graph 510 depicting an example of a monitored electrical signal response of the component under test in FIG. 6 which is disconnected where an electrical test pulse was sent to the one or more other components of the scientific instrument. As can be seen in the graph 510, the electrical response signal does not include any notable spikes (above a threshold and/or within a predetermined range, for example) indicating that the component under test is not functioning properly. In this instance, the component under test is disconnected. The response signal that is measured may include only noise and/or interference, for example.

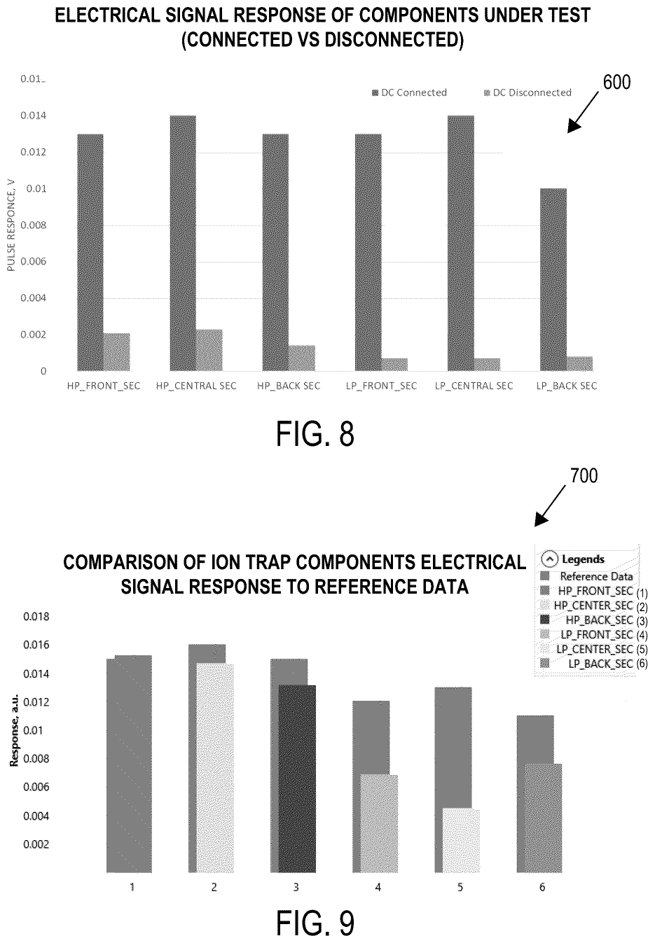

FIG. 8 is a graph 600 illustrating an example of an electrical response signal of various different components under test (one or more electrical test pulses are generated in one or more other components of the instrument) where the components are connected vs disconnected. Each component illustrated in the graph 600 contains a connected pulse response signal (left bar) and a disconnected pulse response signal (right bar). As can be seen in the graph 600, the magnitude of the electrical signal response (which may be a singular signal magnitude, a peak magnitude, and/or an average magnitude, for example) is different between a connected component and a disconnected component. As can be seen in FIG. 8, the voltage of the electrical signal response is monitored and recorded. Other characteristics of the electrical signal response may be monitored in addition to, or in lieu of, voltage such as current, for example.

FIG. 9 is a graph 700 comparing an example of ion trap electrical response signals of various different components of the ion trap as compared to reference data (reference data indicating a fully operational magnitude value). Each component illustrated in the graph 700 contains reference data (left bar) and response signal data (right bar). The response signal (the right-most bar of each component on the x axis) may be compared to the reference data (the left-most bar of each component on the x axis) to determine if the component is functioning properly. As can be seen in FIG. 9, the response signal measured is current.

In at least one instance, an electrical signal, or pulse, can be generated in one or more components simultaneously to induce an electrical response signal, via capacitive coupling, in one or more other components under test. In at least one instance, multiple components can be monitored simultaneously for induced electrical response signals while one or more electrical signals, or pulses, are generated in one or more other components.

The components being tested for operational status can be groups of components. In at least one instance, the methods and systems disclosed herein sequentially test neighboring components by generating an electrical signal, or pulse, in a first component and monitor the electrical response signal induced, by the pulse, in the second component downstream of the first component. The method and systems disclosed herein may then generate an electrical signal, or pulse, in the second component and monitor the electrical response signal induced, by the pulse, in a third component downstream of the second component. In at least one instance, the electrical response signal can further be monitored in the first component upstream of the second component when a test pulse is generated in the second component. In such an instance, the methods and systems disclosed herein can monitor each adjacent component to the component that receives the test pulse (first upstream component and first downstream component).

In at least one instance, the systems of the mass spectrometer may indicate a signal issue in one or more general sections (containing one or more components) of the instrument before, during, and/or after normal use. In such an instance, the general section of components may be targeted by the diagnostic methods and systems disclosed herein. The general section of components can be selected by a user and/or automatically by the methods disclosed herein. In at least one instance, a signal output issue of a particular section of the instrument can cause the diagnostic methods and systems disclosed herein to quickly and directly target the components in that section of the instrument.

In at least one instance, one or more of the diagnostic methods disclosed herein can be performed automatically by the mass spectrometer whether triggered by a particular event or performed at a regular interval. For example, one or more of the diagnostic methods can be initiated as soon as a signal issue is detected by the mass spectrometer. In at least one instance, the one or more diagnostic methods can be initiated in between experiments while the mass spectrometer is still in a vacuum state. In at least one instance, the one or more diagnostic methods can be initiated prior to shut down and/or immediately after a startup sequence. In at least one instance, the one or more diagnostic methods can be performed prior to the instrument achieving a vacuum state and/or immediately after transitioning out of the vacuum state. The one or more diagnostic methods can be run on a regular interval such as, for example, once a day and/or once a week.

The generated electrical signal, or pulse, can be any suitable type of electrical signal such as, for example, a DC potential, a voltage pulse, and/or a current pulse. The electrical response signal can be measured in any suitable fashion such as, for example, measuring then DC voltage potential or electrical current at the connection between a power supply and the component(s) under test. This circuitry may be referred to as a feedback circuit. Any suitable measuring technique can be employed so as to be able to quantify the electrical response signal induced in the component(s) under test.

In at least one instance, the generated electrical signal, or pulse, can be predefined according to the specifications of the component under test and/or the component in which the pulse is being generated. In at least one instance, capacitive coupling characteristics between various components can be predetermined. In at least one instance, the capacitive coupling characteristics are learned for one or more of the components in the mass spectrometer in order to select the most appropriate characteristics of the generated electrical signal, or pulse, to maximize the electrical response signal in the desired component to be tested. In at least one instance, the characteristics of the electrical pulse are selected to maximize the electrical response signal in the device under test. In at least one instance, several components are tested simultaneously. In at least one instance, a series of electrical signals, or pulses, are generated in a single component under test over a period of time and the average of the induced electrical response signal is observed and compared to reference data. In at least one instance, a series of electrical signals, or pulses, are generated in several different components over a period of time. In at least one instance, the characteristics of the electrical signal, or pulse, is selected so as to reduce the effect of noise on the test and, specifically, the electrical response signal, for example.

In at least one instance, the generated electrical signal, or pulse, is not uniform in width, amplitude, and/or waveform between tests and/or during a single test. In at least one instance, a series of electrical signals, or pulses, with different characteristics are cycled through the various components of an instrument and, based on a desired outcome (maximum induced electrical response signal strength, for example) of the induced electrical response signals in test components as a result of the series of different electrical pulses, the support module automatically selects the pulse characteristics for subsequent tests.

In at least one instance, one or more of the subcircuits of the instrument components include circuitry including resistors that may fail over time. The methods and systems disclosed herein can identify the faulty component (such as a resistor, for example) and, thus, the faulty circuits containing the broken resistor, for example.

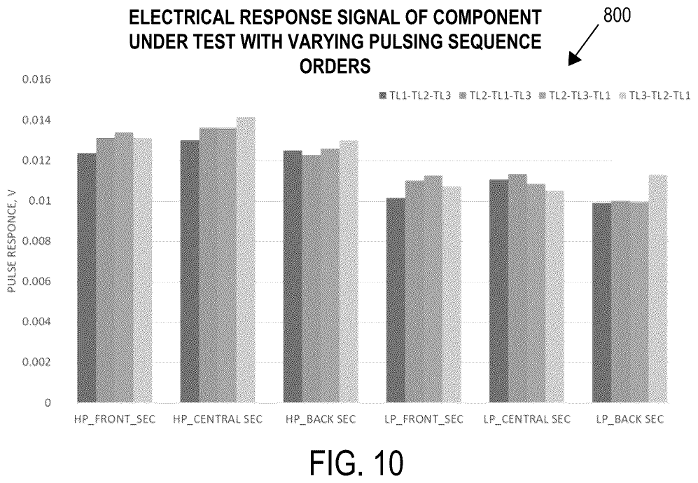

In at least one instance, the generated electrical pulse is between about −150V and +150V, for example. However, as discussed herein, any suitable pulse characteristics can be selected. In at least one instance, when generating pulses in several components, the pulses are not instantaneous and there may be a delay in how long it takes for the pulse to occur in the desired component (30 microseconds, for example). As discussed herein, multiple components may be pulsed simultaneously to test neighboring components. In at least one instance, each lens in a dual pressure linear ion trap is pulsed to induce an electrical response signal in each section of the high pressure trap and each section of the low pressure trap. The sections may include endcap electrodes and a ring electrode, for example. The front sections of each trap may include an endcap electrode, the back sections of each trap may include an endcap electrode, and the central section of each trap may include a ring electrode. FIG. 10 shows a graph 800 illustrating electrical response signals of front sections, center sections, and back sections of the high pressure trap and the low pressure trap when simultaneously (with the slight delay discussed herein, though embodiments are contemplated where there is no delay, less delay, or more delay) sending pulses to three lenses (one positioned before the high pressure trap (TL1), one positioned between the two traps (TL2), and one positioned after the low pressure trap (TL3). As can be seen in the graph 800, the order in which the pulses are generated in the three lenses TL1, TL2, and TL3 to test each trap section alters the magnitude of the electrical response signal in each trap section. In at least one instance, the support modules disclosed herein automatically sequences through every possible order for each trap section to maximize the electrical response signal for each trap section. In another instance, the support modules disclosed herein obtains the optimal order of pulsing from a database based on the component being tested and employs that order when testing a component.

Four different lens pulse orders are illustrated in FIG. 10 for each trap section. The left bar on the graph for each section is TL1-TL2-TL3, the middle left bar on the graph for each section is TL2-TL1-TL3, the middle right bar on the graph for each section is TL2-TL3-TL1, and the right bar on the graph for each section is TL3-TL2-TL1. In at least one instance, the middle left bar representing the order of TL2-TL1-TL3 may be comprised of overall higher signal amplitude than the other orders illustrated.

In at least one instance, the support modules disclosed herein select the component within which to generate an electrical signal in based on the physical distance to the component under test and/or the capacitive coupling relationship between the two. In at least one instance, the physical distance is contained in a database and the support modules disclosed herein select the test components based on this information to maximize electrical response signals, for example.

In at least one instance, the support modules disclosed herein compare results of several different components for a single component under test. For example, the support modules may run several different tests on a single component under test by generating electrical pulses in various different components of the scientific instrument. The support modules disclosed herein may then compare the results of each of the tests and/or look at the aggregate of the results to determine the operational status of the component under test. Such an arrangement can serve to as a multiple-check verification of a determined operational status of a component under test.

In at least one instance, the methods and systems disclosed herein are also implemented to test a quadrupole, for example. Surrounding components of the quadrupole can be pulsed while the DC electrical response signal of the quadrupole is monitored.

In at least one instance, a Fourier analysis is applied to an electrical response signal by an analysis logic to decompose the signal. Such decomposition may help determine what, exactly, an issue is with a particular component. In at least one instance, a more comprehensive analysis of the electrical response signal can help discern the signal induced by capacitive coupling with the methods and systems disclosed herein from noise and/or interference.

In at least one instance, the profiles of the electrical test pulses are updated over time automatically to maximize electrical response signal strength in components under test. In at least one instance, the pulse profile is selected based on a desired electrical response signal of the component under test. The desired electrical response signal may vary depending on the type of issue being detected and/or determined.

In at least one instance, components being tested and components being pulsed are selected based on relative capacitive coupling capacity. In other words, two neighboring components (a first component under test and a second component to be pulsed) may provide the closest combination of components in physical distance to each other. However, if a third component that is further from the first component than the second component but is larger than the second component, pulsing the third component may induce a greater response signal in the first component because of the combination of its close proximity in addition to its size and, thus, relative capacitive coupling capacity.

In at least one instance, inductive coupling is used to transfer electrical energy between components.

The scientific instrument support methods disclosed herein may include interactions with a human user (e.g., via the user local computing device 5020 discussed herein with reference to FIG. 13). These interactions may include providing information to the user (e.g., information regarding the operation of a scientific instrument such as the scientific instrument 5010 of FIG. 13, information regarding a sample being analyzed or other test or measurement performed by a scientific instrument, information retrieved from a local or remote database, or other information) or providing an option for a user to input commands (e.g., to control the operation of a scientific instrument such as the scientific instrument 5010 of FIG. 13, or to control the analysis of data generated by a scientific instrument), queries (e.g., to a local or remote database), or other information. In some embodiments, these interactions may be performed through a graphical user interface (GUI) that includes a visual display on a display device (e.g., the display device 4010 discussed herein with reference to FIG. 12) that provides outputs to the user and/or prompts the user to provide inputs (e.g., via one or more input devices, such as a keyboard, mouse, trackpad, or touchscreen, included in the other I/O devices 4012 discussed herein with reference to FIG. 12). The scientific instrument support systems disclosed herein may include any suitable GUIs for interaction with a user.

FIG. 11 depicts an example GUI 3000 that may be used in the performance of some or all of the support methods disclosed herein, in accordance with various embodiments. As noted above, the GUI 3000 may be provided on a display device (e.g., the display device 4010 discussed herein with reference to FIG. 12) of a computing device (e.g., the computing device 4000 discussed herein with reference to FIG. 12) of a scientific instrument support system (e.g., the scientific instrument support system 5000 discussed herein with reference to FIG. 13), and a user may interact with the GUI 3000 using any suitable input device (e.g., any of the input devices included in the other I/O devices 4012 discussed herein with reference to FIG. 12) and input technique (e.g., movement of a cursor, motion capture, facial recognition, gesture detection, voice recognition, actuation of buttons, etc.).

The GUI 3000 may include a data display region 3002, a data analysis region 3004, a scientific instrument control region 3006, and a settings region 3008. The particular number and arrangement of regions depicted in FIG. 11 is simply illustrative, and any number and arrangement of regions, including any desired features, may be included in a GUI 3000.

The data display region 3002 may display data generated by a scientific instrument (e.g., the scientific instrument 5010 discussed herein with reference to FIG. 13). For example, the data display region 3002 may display potential instrument signal issues triggering a diagnostic method such as the methods and systems disclosed herein, determined component fixes, determined component statuses, monitored electrical response signal(s), and/or generated electrical test pulses.

The data analysis region 3004 may display the results of data analysis (e.g., the results of analyzing the data illustrated in the data display region 3002 and/or other data). For example, the data analysis region 3004 may display analysis of the electrical response signal(s), for example. In some embodiments, the data display region 3002 and the data analysis region 3004 may be combined in the GUI 3000 (e.g., to include data output from a scientific instrument, and some analysis of the data, in a common graph or region).

The scientific instrument control region 3006 may include options that allow the user to control a scientific instrument (e.g., the scientific instrument 5010 discussed herein with reference to FIG. 13). For example, the scientific instrument control region 3006 may include component test functions corresponding to the methods and systems disclosed herein. The control region 3006 may include options for initiating specific component tests, initiating entire instrument tests where every component is tested, selecting which component to test, selecting pulse characteristics, and/or selecting the format of the results, for example.

The settings region 3008 may include options that allow the user to control the features and functions of the GUI 3000 (and/or other GUIs) and/or perform common computing operations with respect to the data display region 3002 and data analysis region 3004 (e.g., saving data on a storage device, such as the storage device 4004 discussed herein with reference to FIG. 12, sending data to another user, labeling data, etc.). For example, the settings region 3008 may include setting particular pulse characteristics, for example.

As noted above, the scientific instrument support module 1000 may be implemented by one or more computing devices. FIG. 12 is a block diagram of a computing device 4000 that may perform some or all of the scientific instrument support methods disclosed herein, in accordance with various embodiments. In some embodiments, the scientific instrument support module 1000 may be implemented by a single computing device 4000 or by multiple computing devices 4000. Further, as discussed below, a computing device 4000 (or multiple computing devices 4000) that implements the scientific instrument support module 1000 may be part of one or more of the scientific instrument 5010, the user local computing device 5020, the service local computing device 5030, or the remote computing device 5040 of FIG. 13.

The computing device 4000 of FIG. 12 is illustrated as having a number of components, but any one or more of these components may be omitted or duplicated, as suitable for the application and setting. In some embodiments, some or all of the components included in the computing device 4000 may be attached to one or more motherboards and enclosed in a housing (e.g., including plastic, metal, and/or other materials). In some embodiments, some of these components may be fabricated onto a single system-on-a-chip (SoC) (e.g., an SoC may include one or more processing devices 4002 and one or more storage devices 4004). Additionally, in various embodiments, the computing device 4000 may not include one or more of the components illustrated in FIG. 12, but may include interface circuitry (not shown) for coupling to the one or more components using any suitable interface (e.g., a Universal Serial Bus (USB) interface, a High-Definition Multimedia Interface (HDMI) interface, a Controller Area Network (CAN) interface, a Serial Peripheral Interface (SPI) interface, an Ethernet interface, a wireless interface, or any other appropriate interface). For example, the computing device 4000 may not include a display device 4010, but may include display device interface circuitry (e.g., a connector and driver circuitry) to which a display device 4010 may be coupled.

The computing device 4000 may include a processing device 4002 (e.g., one or more processing devices). As used herein, the term “processing device” may refer to any device or portion of a device that processes electronic data from registers and/or memory to transform that electronic data into other electronic data that may be stored in registers and/or memory. The processing device 4002 may include one or more digital signal processors (DSPs), application-specific integrated circuits (ASICs), central processing units (CPUs), graphics processing units (GPUs), cryptoprocessors (specialized processors that execute cryptographic algorithms within hardware), server processors, or any other suitable processing devices.

The computing device 4000 may include a storage device 4004 (e.g., one or more storage devices). The storage device 4004 may include one or more memory devices such as random access memory (RAM) (e.g., static RAM (SRAM) devices, magnetic RAM (MRAM) devices, dynamic RAM (DRAM) devices, resistive RAM (RRAM) devices, or conductive-bridging RAM (CBRAM) devices), hard drive-based memory devices, solid-state memory devices, networked drives, cloud drives, or any combination of memory devices. In some embodiments, the storage device 4004 may include memory that shares a die with a processing device 4002. In such an embodiment, the memory may be used as cache memory and may include embedded dynamic random access memory (eDRAM) or spin transfer torque magnetic random access memory (STT-MRAM), for example. In some embodiments, the storage device 4004 may include non-transitory computer readable media having instructions thereon that, when executed by one or more processing devices (e.g., the processing device 4002), cause the computing device 4000 to perform any appropriate ones of or portions of the methods disclosed herein.

The computing device 4000 may include an interface device 4006 (e.g., one or more interface devices 4006). The interface device 4006 may include one or more communication chips, connectors, and/or other hardware and software to govern communications between the computing device 4000 and other computing devices. For example, the interface device 4006 may include circuitry for managing wireless communications for the transfer of data to and from the computing device 4000. The term “wireless” and its derivatives may be used to describe circuits, devices, systems, methods, techniques, communications channels, etc., that may communicate data through the use of modulated electromagnetic radiation through a nonsolid medium. The term does not imply that the associated devices do not contain any wires, although in some embodiments they might not. Circuitry included in the interface device 4006 for managing wireless communications may implement any of a number of wireless standards or protocols, including but not limited to Institute for Electrical and Electronic Engineers (IEEE) standards including Wi-Fi (IEEE 802.11 family), IEEE 802.16 standards (e.g., IEEE 802.16-2005 Amendment), Long-Term Evolution (LTE) project along with any amendments, updates, and/or revisions (e.g., advanced LTE project, ultra mobile broadband (UMB) project (also referred to as “3GPP2”), etc.). In some embodiments, circuitry included in the interface device 4006 for managing wireless communications may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. In some embodiments, circuitry included in the interface device 4006 for managing wireless communications may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). In some embodiments, circuitry included in the interface device 4006 for managing wireless communications may operate in accordance with Code Division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. In some embodiments, the interface device 4006 may include one or more antennas (e.g., one or more antenna arrays) to receipt and/or transmission of wireless communications.

In some embodiments, the interface device 4006 may include circuitry for managing wired communications, such as electrical, optical, or any other suitable communication protocols. For example, the interface device 4006 may include circuitry to support communications in accordance with Ethernet technologies. In some embodiments, the interface device 4006 may support both wireless and wired communication, and/or may support multiple wired communication protocols and/or multiple wireless communication protocols. For example, a first set of circuitry of the interface device 4006 may be dedicated to shorter-range wireless communications such as Wi-Fi or Bluetooth, and a second set of circuitry of the interface device 4006 may be dedicated to longer-range wireless communications such as global positioning system (GPS), EDGE, GPRS, CDMA, WiMAX, LTE, EV-DO, or others. In some embodiments, a first set of circuitry of the interface device 4006 may be dedicated to wireless communications, and a second set of circuitry of the interface device 4006 may be dedicated to wired communications.

The computing device 4000 may include battery/power circuitry 4008. The battery/power circuitry 4008 may include one or more energy storage devices (e.g., batteries or capacitors) and/or circuitry for coupling components of the computing device 4000 to an energy source separate from the computing device 4000 (e.g., AC line power).

The computing device 4000 may include a display device 4010 (e.g., multiple display devices). The display device 4010 may include any visual indicators, such as a heads-up display, a computer monitor, a projector, a touchscreen display, a liquid crystal display (LCD), a light-emitting diode display, or a flat panel display.

The computing device 4000 may include other input/output (I/O) devices 4012. The other I/O devices 4012 may include one or more audio output devices (e.g., speakers, headsets, earbuds, alarms, etc.), one or more audio input devices (e.g., microphones or microphone arrays), location devices (e.g., GPS devices in communication with a satellite-based system to receive a location of the computing device 4000, as known in the art), audio codecs, video codecs, printers, sensors (e.g., thermocouples or other temperature sensors, humidity sensors, pressure sensors, vibration sensors, accelerometers, gyroscopes, etc.), image capture devices such as cameras, keyboards, cursor control devices such as a mouse, a stylus, a trackball, or a touchpad, bar code readers, Quick Response (QR) code readers, or radio frequency identification (RFID) readers, for example.

The computing device 4000 may have any suitable form factor for its application and setting, such as a handheld or mobile computing device (e.g., a cell phone, a smart phone, a mobile internet device, a tablet computer, a laptop computer, a netbook computer, an ultrabook computer, a personal digital assistant (PDA), an ultra mobile personal computer, etc.), a desktop computing device, or a server computing device or other networked computing component.

One or more computing devices implementing any of the scientific instrument support modules or methods disclosed herein may be part of a scientific instrument support system. FIG. 13 is a block diagram of an example scientific instrument support system 5000 in which some or all of the scientific instrument support methods disclosed herein may be performed, in accordance with various embodiments. The scientific instrument support modules and methods disclosed herein (e.g., the scientific instrument support module 300 of FIG. 3 and the methods 400 and/or 410 of FIGS. 4 and 5) may be implemented by one or more of the scientific instrument 5010, the user local computing device 5020, the service local computing device 5030, or the remote computing device 5040 of the scientific instrument support system 5000.

Any of the scientific instrument 5010, the user local computing device 5020, the service local computing device 5030, or the remote computing device 5040 may include any of the embodiments of the computing device 4000 discussed herein with reference to FIG. 12, and any of the scientific instrument 5010, the user local computing device 5020, the service local computing device 5030, or the remote computing device 5040 may take the form of any appropriate ones of the embodiments of the computing device 4000 discussed herein with reference to FIG. 12.

The scientific instrument 5010, the user local computing device 5020, the service local computing device 5030, or the remote computing device 5040 may each include a processing device 5002, a storage device 5004, and an interface device 5006. The processing device 5002 may take any suitable form, including the form of any of the processing devices 4002 discussed herein with reference to FIG. 12, and the processing devices 5002 included in different ones of the scientific instrument 5010, the user local computing device 5020, the service local computing device 5030, or the remote computing device 5040 may take the same form or different forms. The storage device 5004 may take any suitable form, including the form of any of the storage devices 4004 discussed herein with reference to FIG. 12, and the storage devices 5004 included in different ones of the scientific instrument 5010, the user local computing device 5020, the service local computing device 5030, or the remote computing device 5040 may take the same form or different forms. The interface device 5006 may take any suitable form, including the form of any of the interface devices 4006 discussed herein with reference to FIG. 12, and the interface devices 5006 included in different ones of the scientific instrument 5010, the user local computing device 5020, the service local computing device 5030, or the remote computing device 5040 may take the same form or different forms.

The scientific instrument 5010, the user local computing device 5020, the service local computing device 5030, and the remote computing device 5040 may be in communication with other elements of the scientific instrument support system 5000 via communication pathways 5008. The communication pathways 5008 may communicatively couple the interface devices 5006 of different ones of the elements of the scientific instrument support system 5000, as shown, and may be wired or wireless communication pathways (e.g., in accordance with any of the communication techniques discussed herein with reference to the interface devices 4006 of the computing device 4000 of FIG. 12). The particular scientific instrument support system 5000 depicted in FIG. 13 includes communication pathways between each pair of the scientific instrument 5010, the user local computing device 5020, the service local computing device 5030, and the remote computing device 5040, but this “fully connected” implementation is simply illustrative, and in various embodiments, various ones of the communication pathways 5008 may be absent. For example, in some embodiments, a service local computing device 5030 may not have a direct communication pathway 5008 between its interface device 5006 and the interface device 5006 of the scientific instrument 5010, but may instead communicate with the scientific instrument 5010 via the communication pathway 5008 between the service local computing device 5030 and the user local computing device 5020 and the communication pathway 5008 between the user local computing device 5020 and the scientific instrument 5010.

The scientific instrument 5010 may include any appropriate scientific instrument, such as the mass spectrometers and/or associated environments disclosed herein.

The user local computing device 5020 may be a computing device (e.g., in accordance with any of the embodiments of the computing device 4000 discussed herein) that is local to a user of the scientific instrument 5010. In some embodiments, the user local computing device 5020 may also be local to the scientific instrument 5010, but this need not be the case; for example, a user local computing device 5020 that is in a user's home or office may be remote from, but in communication with, the scientific instrument 5010 so that the user may use the user local computing device 5020 to control and/or access data from the scientific instrument 5010. In some embodiments, the user local computing device 5020 may be a laptop, smartphone, or tablet device. In some embodiments the user local computing device 5020 may be a portable computing device.

The service local computing device 5030 may be a computing device (e.g., in accordance with any of the embodiments of the computing device 4000 discussed herein) that is local to an entity that services the scientific instrument 5010. For example, the service local computing device 5030 may be local to a manufacturer of the scientific instrument 5010 or to a third-party service company. In some embodiments, the service local computing device 5030 may communicate with the scientific instrument 5010, the user local computing device 5020, and/or the remote computing device 5040 (e.g., via a direct communication pathway 5008 or via multiple “indirect” communication pathways 5008, as discussed above) to receive data regarding the operation of the scientific instrument 5010, the user local computing device 5020, and/or the remote computing device 5040 (e.g., the results of self-tests of the scientific instrument 5010, calibration coefficients used by the scientific instrument 5010, the measurements of sensors associated with the scientific instrument 5010, etc.). In some embodiments, the service local computing device 5030 may communicate with the scientific instrument 5010, the user local computing device 5020, and/or the remote computing device 5040 (e.g., via a direct communication pathway 5008 or via multiple “indirect” communication pathways 5008, as discussed above) to transmit data to the scientific instrument 5010, the user local computing device 5020, and/or the remote computing device 5040 (e.g., to update programmed instructions, such as firmware, in the scientific instrument 5010, to initiate the performance of test or calibration sequences in the scientific instrument 5010, to update programmed instructions, such as software, in the user local computing device 5020 or the remote computing device 5040, etc.). A user of the scientific instrument 5010 may utilize the scientific instrument 5010 or the user local computing device 5020 to communicate with the service local computing device 5030 to report a problem with the scientific instrument 5010 or the user local computing device 5020, to request a visit from a technician to improve the operation of the scientific instrument 5010, to order consumables or replacement parts associated with the scientific instrument 5010, or for other purposes.

The remote computing device 5040 may be a computing device (e.g., in accordance with any of the embodiments of the computing device 4000 discussed herein) that is remote from the scientific instrument 5010 and/or from the user local computing device 5020. In some embodiments, the remote computing device 5040 may be included in a datacenter or other large-scale server environment. In some embodiments, the remote computing device 5040 may include network-attached storage (e.g., as part of the storage device 5004). The remote computing device 5040 may store data generated by the scientific instrument 5010, perform analyses of the data generated by the scientific instrument 5010 (e.g., in accordance with programmed instructions), facilitate communication between the user local computing device 5020 and the scientific instrument 5010, and/or facilitate communication between the service local computing device 5030 and the scientific instrument 5010.

In some embodiments, one or more of the elements of the scientific instrument support system 5000 illustrated in FIG. 13 may not be present. Further, in some embodiments, multiple ones of various ones of the elements of the scientific instrument support system 5000 of FIG. 13 may be present. For example, a scientific instrument support system 5000 may include multiple user local computing devices 5020 (e.g., different user local computing devices 5020 associated with different users or in different locations). In another example, a scientific instrument support system 5000 may include multiple scientific instruments 5010, all in communication with service local computing device 5030 and/or a remote computing device 5040; in such an embodiment, the service local computing device 5030 may monitor these multiple scientific instruments 5010, and the service local computing device 5030 may cause updates or other information may be “broadcast” to multiple scientific instruments 5010 at the same time. Different ones of the scientific instruments 5010 in a scientific instrument support system 5000 may be located close to one another (e.g., in the same room) or farther from one another (e.g., on different floors of a building, in different buildings, in different cities, etc.). In some embodiments, a scientific instrument 5010 may be connected to an Internet-of-Things (IoT) stack that allows for command and control of the scientific instrument 5010 through a web-based application, a virtual or augmented reality application, a mobile application, and/or a desktop application. Any of these applications may be accessed by a user operating the user local computing device 5020 in communication with the scientific instrument 5010 by the intervening remote computing device 5040. In some embodiments, a scientific instrument 5010 may be sold by the manufacturer along with one or more associated user local computing devices 5020 as part of a local scientific instrument computing unit 5012.

In some embodiments, different ones of the scientific instruments 5010 included in a scientific instrument support system 5000 may be different types of scientific instruments 5010; for example, one scientific instrument 5010 may be a mass spectrometer, while another scientific instrument 5010 may include any instrument within electrically coupled components capable of inducing an electrical response signal in one or more other components. In some such embodiments, the remote computing device 5040 and/or the user local computing device 5020 may combine data from different types of scientific instruments 5010 included in a scientific instrument support system 5000.

The following paragraphs provide various examples of the embodiments disclosed herein.

Example 1 is a scientific instrument support apparatus, comprising first logic to generate an electrical signal in a first component of a scientific instrument, wherein the generated electrical signal induces, through capacitive coupling, an electrical response signal in a second component of the scientific instrument, second logic to monitor the electrical response signal induced in the second component, third logic to determine an operational status of the second component based on the monitored electrical response signal, wherein the operational status indicates that the second component is not functioning properly when the monitored electrical response signal is not within a predetermined signal range, and fourth logic to display the determined operational status of the second component to a user.

Example 2 may include the subject matter of Example 1, and may further specify that the scientific instrument support apparatus comprises fifth logic to receive an input to activate a standby mode of the instrument before generating the electrical signal.

Example 3 may include the subject matter of any one of Examples 1 or 2, and may further specify that wherein activating the standby mode includes setting the first component and the second component to zero potential prior to generating the electrical signal.

Example 4 may include the subject matter of any one of Examples 1-3, and may further specify that the scientific instrument support apparatus comprises fifth logic to determine an issue with the second component upon determining that the operational status of the second component indicates that the second component is not functioning properly, wherein the issue is based on the monitored electrical response signal, and sixth logic to display, to a user, the determined issue and a recommended fix for the determined issue.

Example 5 may include the subject matter of any one of Examples 1-4, and may further wherein a characteristic of the generated electrical signal is selected based on a type of component being tested.

Example 6 may include the subject matter of any one of Examples 1-5, and may further specify that wherein the characteristic is one of a signal magnitude, a signal width, or a signal frequency.

Example 7 may include the subject matter of any one of Examples 1-6, and may further specify that wherein the electrical signal comprises an electrical pulse.

Example 8 may include the subject matter of any one of Examples 1-7, and may further specify that wherein the first component comprises a plurality of first components.

Example 9 may include the subject matter of any one of Examples 1-8, and may further specify that wherein the second component comprises a plurality of second components.

Example 10 may include the subject matter of any one of Examples 1-9, and may further specify that wherein the electrical signal comprises a voltage pulse of between about −150V and 150V.

Example 11 may include the subject matter of any one of Examples 1-10, and may further specify that wherein the first logic is to generate a second electrical signal in a third component of the scientific instrument, wherein the generated second electrical signal induces, through capacitive coupling, a second electrical response signal in the second component of the scientific instrument, the second logic is to monitor the second electrical response signal in the second component, and the third logic is to determine the operational status of the second component based on the monitored electrical signal and the monitored second electrical response signal.

Example 12 may include the subject matter of any one of Examples 1-11, and may further specify that wherein the first logic is to generate a second electrical signal in the second component of the scientific instrument, wherein the generated second electrical signal induces, through capacitive coupling, a second electrical response signal in a third component of the scientific instrument, the second logic is to monitor the second electrical response signal in the third component, and the third logic is to determine the operational status of the third component based on the monitored second electrical response signal.

Example 13 may include the subject matter of any one of Examples 1-12, and may further specify that wherein the electrical signal comprises a plurality of electrical signals, and wherein the third logic determines an operational status of the second component based on an average of the monitored electrical current induced in the second component of the scientific instrument by the series of electrical test pulses.

Example 14 may include the subject matter of any one of Examples 1-13, and may further specify wherein the scientific instrument comprises a mass spectrometer, and wherein the first component comprises a first ion optic device and the second component comprises a second ion optic device.

Example 15 is a method for scientific instrument support comprising setting a first component of a scientific instrument and a second component of the scientific instrument to a zero potential, generating a plurality of electrical pulses in the first component to induce, through capacitive coupling, an electrical potential in the second component, monitoring the electrical potential of the second component induced by the plurality of electrical pulses, determining an operational status of the second component based on the monitored electrical potential of the second component, wherein the operational status is operational when an average of the monitored electrical potentials of the second component induced by the plurality of electrical pulses is within a predetermined range, and wherein the operational status is non-operational when the average of the monitored electrical potentials of the second component induced by the plurality of electrical pulses is not within the predetermine range, and providing the determined operational status to a user.

Example 16 may include one or more non-transitory computer readable media having instructions thereon that, when executed by one or more processing devices of a scientific instrument support apparatus, cause the scientific instrument support apparatus to perform the method of Example 15.

Example 17 is a scientific instrument support apparatus comprising first logic to generate an electrical signal in a first component of a scientific instrument, wherein the generated electrical signal induces, through capacitive coupling, an electrical response signal in a second component of the scientific instrument, second logic to monitor the electrical response signal induced in the second component, third logic to determine an operational status of the second component based on the monitored electrical response signal, wherein the operational status indicates that the second component is not functioning properly when the monitored electrical response signal is not within a predetermined response signal range, and fourth logic to display the determined operational status of the second component to a user.

Example 18 may include the subject matter of Example 17, further comprising fifth logic to receive an input to activate a standby mode of the instrument before generating the electrical signal.

Example 19 may include the subject matter of any one of Examples 17 or 18, wherein activating the standby mode includes setting the first component and the second component to zero electrical potential prior to generating the electrical signal.

Example 20 may include the subject matter of any one of Examples 17-19, further comprising fifth logic to determine an issue with the second component upon determining that the operational status of the second component indicates that the second component is not functioning properly, wherein the issue is based on the monitored electrical response signal, and sixth logic to display, to a user, the determined issue and a recommended fix for the determined issue.

Example 21 may include the subject matter of any one of Examples 17-20, wherein a characteristic of the generated electrical signal is selected based on a type of component being tested.

Example 22 may include the subject matter of Example 21, wherein the characteristic is one of a signal magnitude, a signal width, or a signal frequency.

Example 23 may include the subject matter of any one of Examples 17-22, wherein the electrical signal comprises an electrical pulse generated by a power supply connected to the first component.

Example 24 may include the subject matter of any one of Examples 17-23, wherein the first component comprises a plurality of first components.

Example 25 may include the subject matter of Example 24, wherein the second component comprises a plurality of second components.

Example 26 may include the subject matter of any one of Examples 17-25, wherein the electrical signal comprises a voltage pulse of between about −150V and about 150V.

Example 27 may include the subject matter of any one of Examples 17-26, wherein the first logic is to generate a second electrical signal in a third component of the scientific instrument, wherein the generated second electrical signal induces, through capacitive coupling, a second electrical response signal in the second component of the scientific instrument, the second logic is to monitor the second electrical response signal in the second component, the third logic is to determine the operational status of the second component based on the monitored electrical signal and the monitored second electrical response signal.

Example 28 may include the subject matter of any one of Examples 17-27, wherein the first logic is to generate a second electrical signal in the second component of the scientific instrument, wherein the generated second electrical signal induces, through capacitive coupling, a second electrical response signal in a third component of the scientific instrument, the second logic is to monitor the second electrical response signal in the third component, and the third logic is to determine the operational status of the second component based on the monitored second electrical response signal.

Example 29 may include the subject matter of any one of Examples 17-28, wherein the electrical signal comprises a plurality of electrical signals, and wherein the third logic determines an operational status of the second component based on an average of the monitored electrical response signals induced in the second component of the scientific instrument by the plurality of electrical signals.

Example 30 may include the subject matter of any one of Examples 17-29, wherein the scientific instrument comprises a mass spectrometer, wherein the first component comprises a first ion optic device and the second component comprises a second ion optic device.

Example 31 is a method for scientific instrument support comprising setting a first component of a scientific instrument and a second component of the scientific instrument to a zero electrical potential, generating a plurality of electrical pulses in the first component to induce, through capacitive coupling, electrical response signals in the second component, monitoring the electrical response signals of the second component induced by the plurality of electrical pulses, determining an operational status of the second component based on the monitored electrical response signals of the second component, wherein the operational status is operational when an average of the monitored electrical response signals of the second component induced by the plurality of electrical pulses is within a predetermined operational range, and wherein the operational status is non-operational when the average of the monitored electrical response signals of the second component induced by the plurality of electrical pulses is not within the predetermine operational range, and providing the determined operational status.

Example 32 is one or more non-transitory computer readable media having instructions thereon that, when executed by one or more processing devices of a scientific instrument support apparatus, cause the scientific instrument support apparatus to perform the method of Example 31.

Example 33 may include the subject matter of any one of Examples 31 or 32, wherein the first component comprises a plurality of first components.

Example 34 may include the subject matter of any one of Examples 31-33, wherein the second component comprises a plurality of second components.

Example 35 is a scientific instrument support apparatus comprising generating logic to generate an electrical signal in a first component of a scientific instrument, monitoring logic to monitor an electrical response signal in a second component of the scientific instrument induced by the electrical signal, and determining logic to determine an operational status of the second component based on the monitored electrical response signal.

Example 36 may include the subject matter of Example 35, wherein at least one characteristic of the electrical signal is selected based on at least one of the type of component of the first component or the type of component of the second component.

Example A includes any of the scientific instrument support modules disclosed herein.

Example B includes any of the methods disclosed herein.

Example C includes any of the GUIs disclosed herein.

Example D includes any of the scientific instrument support computing devices and systems disclosed herein.

1. A scientific instrument support apparatus, comprising:
first logic to generate an electrical signal in a first component of a scientific instrument, wherein the generated electrical signal induces, through capacitive coupling, an electrical response signal in a second component of the scientific instrument;
second logic to monitor the electrical response signal induced in the second component;
third logic to determine an operational status of the second component based on the monitored electrical response signal, wherein the operational status indicates that the second component is not functioning properly when the monitored electrical response signal is not within a predetermined response signal range; and
fourth logic to display the determined operational status of the second component to a user.

2. The scientific instrument support apparatus of claim 1, further comprising fifth logic to receive an input to activate a standby mode of the instrument before generating the electrical signal.

3. The scientific instrument support apparatus of claim 2, wherein activating the standby mode includes setting the first component and the second component to zero electrical potential prior to generating the electrical signal.

4. The scientific instrument support apparatus of claim 1, further comprising:
fifth logic to determine an issue with the second component upon determining that the operational status of the second component indicates that the second component is not functioning properly, wherein the issue is based on the monitored electrical response signal; and
sixth logic to display, to a user, the determined issue and a recommended fix for the determined issue.

5. The scientific instrument support apparatus of claim 1, wherein a characteristic of the generated electrical signal is selected based on a type of component being tested.

6. The scientific instrument support apparatus of claim 5, wherein the characteristic is one of a signal magnitude, a signal width, or a signal frequency.

7. The scientific instrument support apparatus of claim 1, wherein the electrical signal comprises an electrical pulse generated by a power supply connected to the first component.

8. The scientific instrument support apparatus of claim 1, wherein the first component comprises a plurality of first components.

9. The scientific instrument support apparatus of claim 8, wherein the second component comprises a plurality of second components.

10. The scientific instrument support apparatus of claim 1, wherein the electrical signal comprises a voltage pulse of between about −150V and about 150V.

11. The scientific instrument support apparatus of claim 1, wherein:
the first logic is to generate a second electrical signal in a third component of the scientific instrument, wherein the generated second electrical signal induces, through capacitive coupling, a second electrical response signal in the second component of the scientific instrument;
the second logic is to monitor the second electrical response signal in the second component;
the third logic is to determine the operational status of the second component based on the monitored electrical signal and the monitored second electrical response signal.

12. The scientific instrument support apparatus of claim 1, wherein:
the first logic is to generate a second electrical signal in the second component of the scientific instrument, wherein the generated second electrical signal induces, through capacitive coupling, a second electrical response signal in a third component of the scientific instrument;
the second logic is to monitor the second electrical response signal in the third component;
the third logic is to determine the operational status of the second component based on the monitored second electrical response signal.

13. The scientific instrument support apparatus of claim 1, wherein the electrical signal comprises a plurality of electrical signals, and wherein the third logic determines an operational status of the second component based on an average of the monitored electrical response signals induced in the second component of the scientific instrument by the plurality of electrical signals.

14. The scientific instrument support apparatus of claim 1, wherein the scientific instrument comprises a mass spectrometer, wherein the first component comprises a first ion optic device and the second component comprises a second ion optic device.

15. A method for scientific instrument support, comprising:
setting a first component of a scientific instrument and a second component of the scientific instrument to a zero electrical potential;
generating a plurality of electrical pulses in the first component to induce, through capacitive coupling, electrical response signals in the second component;
monitoring the electrical response signals of the second component induced by the plurality of electrical pulses;
determining an operational status of the second component based on the monitored electrical response signals of the second component, wherein the operational status is operational when an average of the monitored electrical response signals of the second component induced by the plurality of electrical pulses is within a predetermined operational range, and wherein the operational status is non-operational when the average of the monitored electrical response signals of the second component induced by the plurality of electrical pulses is not within the predetermine operational range;
providing the determined operational status.

16. One or more non-transitory computer readable media having instructions thereon that, when executed by one or more processing devices of a scientific instrument support apparatus, cause the scientific instrument support apparatus to perform the method of claim 15.

17. The method for scientific instrument support of claim 15, wherein the first component comprises a plurality of first components.

18. The method for scientific instrument support of claim 15, wherein the second component comprises a plurality of second components.

19. A scientific instrument support apparatus, comprising:
generating logic to generate an electrical signal in a first component of a scientific instrument;
monitoring logic to monitor an electrical response signal in a second component of the scientific instrument induced by the electrical signal;
determining logic to determine an operational status of the second component based on the monitored electrical response signal.

20. The scientific instrument support apparatus of claim 19, wherein at least one characteristic of the electrical signal is selected based on at least one of the type of component of the first component or the type of component of the second component.
